(19) United States
(12) Patent Application Publication
(10) Pub. No.: US 2009/0161305 A1
(43) Pub. Date: Jun. 25, 2009

(54) KEYBOARD MODULE AND ELECTRONIC DEVICE HAVING THE SAME

(75) Inventors: Ching-Chih Tung, Taipei (TW); Wen-Hung Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/242,785

(22) Filed: Sep. 30, 2008

(30) Foreign Application Priority Data
Dec. 21, 2007 (TW) 96149330

(51) Int. Cl. G06F 1/16

(52) U.S. Cl. 361/679.08

(57) ABSTRACT

An electronic device including a housing, a keyboard module, and a limiting plate is provided. The housing has an accommodation slot including a carrying portion, at least one opening penetrating the carrying portion, and a wedging portion located on the edge of the opening. The keyboard module includes a keyboard disposed in the accommodation slot and at least one wedging element. The keyboard has a first surface facing the carrying portion and a second surface with multiple keys. The wedging element is disposed on the first surface and corresponding to the wedging portion. The wedging portion is limited between the wedging element and the first surface in a first direction perpendicular to the first surface. The limiting plate is disposed in the accommodation slot to limit a displacement of the keyboard module in a second direction.

### CROSS-REFERENCE TO RELATED APPLICATION

This application claims the priority benefit of Taiwan application serial no. 96149330, filed on Dec. 21, 2007. The entirety of the above-mentioned patent application is hereby incorporated by reference herein and made a part of this specification.

### BACKGROUND OF THE INVENTION

1. Field of the Invention

The present invention generally relates to a keyboard module, in particular, to a keyboard module with a wedging element and an electronic device having the same.

2. Description of Related Art

In the current information era, people increasingly rely on electronic devices. Due to demands on high performance and portability, electronic devices, for example, notebook computers have become an indispensable tool in modern people's daily life and work. Generally speaking, a man-machine interface, for example, a keyboard module is usually disposed on the housing of a notebook computer for the user to input instructions, and the internal system of the notebook computer may automatically execute the instructions.

It should be noted that, as the bottom surface of the keyboard module disposed on the housing is difficult to be completely attached to the housing surface, a part of the keyboard module may be raised. Thus, when pressing the keys on the raised area, the user may feel the keys are floating and get an undesirable touch feeling of the keys. In order to solve the problem of key floating, in the conventional art, multiple screws are used to lock the keyboard module onto the housing surface, so as to make the bottom surface of the keyboard module closely attached to the housing surface.

Although the aforementioned manner of using multiple screws to lock the keyboard module onto the housing surface may closely attach the bottom surface of the keyboard module onto the housing surface, the added screws may result in an increased cost of the electronic device. Moreover, the manner of locking the keyboard module onto the housing by screws may also affect the manufacturing performance of the electronic device.

### SUMMARY OF THE INVENTION

Accordingly, the present invention is directed to a keyboard module capable of being evenly and conveniently assembled onto a housing of an electronic device.

The present invention is also directed to an electronic device having a keyboard module, so as to achieve a better manufacturing performance with a lower production cost.

A keyboard module adapted to be fixed on a housing of an electronic device is provided. The housing has an accommodation slot including a carrying portion, at least one opening penetrating the carrying portion, and a first wedging portion located on the edge of the opening. The keyboard module includes a keyboard disposed in the accommodation slot and at least one wedging element. The keyboard has a first surface facing the carrying portion and a second surface opposite to the first surface. In addition, the second surface has multiple keys. The wedging element is disposed on the first surface and corresponding to the first wedging portion. The first wedging portion is limited between the wedging element and the first surface in a first direction perpendicular to the first surface.

In an embodiment of the present invention, the wedging element has a connection portion and a second wedging portion. The connection portion is connected to the first surface, the second wedging portion is bent from the connection portion, and the first wedging portion is limited between the second wedging portion and the first surface.

In an embodiment of the present invention, the wedging element has two connection portions and a second wedging portion. The connection portions are bent from two sides of the second wedging portion, and are connected to the first surface. The first wedging portion is limited between the second wedging portion and the first surface.

An electronic device having a keyboard module includes a housing, a keyboard module, and a limiting plate. The housing has an accommodation slot including a carrying portion, at least one opening penetrating the carrying portion, and a first wedging portion located on the edge of the opening. The keyboard module includes a keyboard disposed in the accommodation slot and at least one wedging element. The keyboard has a first surface facing the carrying portion and a second surface opposite to the first surface. In addition, the second surface has multiple keys. The wedging element is disposed on the first surface and corresponding to the first wedging portion. The first wedging portion is limited between the wedging element and the first surface in a first direction perpendicular to the first surface. The limiting plate is disposed in the accommodation slot to limit a displacement of the keyboard module in a second direction.

In an embodiment of the present invention, the wedging element has a connection portion and a second wedging portion. The connection portion is connected to the first surface, the second wedging portion is bent from the connection portion, and the first wedging portion is limited between the second wedging portion and the first surface.

In an embodiment of the present invention, the wedging element has two connection portions and a second wedging portion. The connection portions are bent from two sides of the second wedging portion, and are connected to the first surface. The first wedging portion is limited between the second wedging portion and the first surface.

In an embodiment of the present invention, the second direction is perpendicular to the first direction.

In an embodiment of the present invention, the housing includes an upper case and a lower case, and the accommodation slot is disposed on the upper case, for the keyboard module to be disposed therein.

In the present invention, at least one wedging element is disposed on a surface of the keyboard facing the accommodation slot. Besides, the engaging relation between the wedging element and the wedging portion of the housing enables the keyboard module to be evenly and conveniently fixed on the housing. Since the electronic device of the present invention adopts a simple structural engaging relation to fix the keyboard module on the housing without requiring the conventional screw-locking process, the electronic device of the present invention achieves a better manufacturing performance with a lower production cost.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of an electronic device having a keyboard module according to an embodiment of the present invention.

FIG. 1B is a partial exploded view of the electronic device of FIG. 1A.

FIG. 1C is a schematic view of a keyboard module and an upper case of FIG. 1B taken from another angle.

FIGS. 2A to 2C are schematic views illustrating processes of assembling the keyboard module of FIG. 1B fixed on accommodation slot.

FIGS. 3A to 3C are schematic views of FIGS. 2A to 2C taken from another angle respectively.

FIG. 4A is a schematic view of a keyboard module fixed on an upper case according to another embodiment.

FIG. 4B IS AN EXPLODED VIEW OF THE KEYBOARD MODULE AND THE UPPER CASE OF FIG. 4A.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

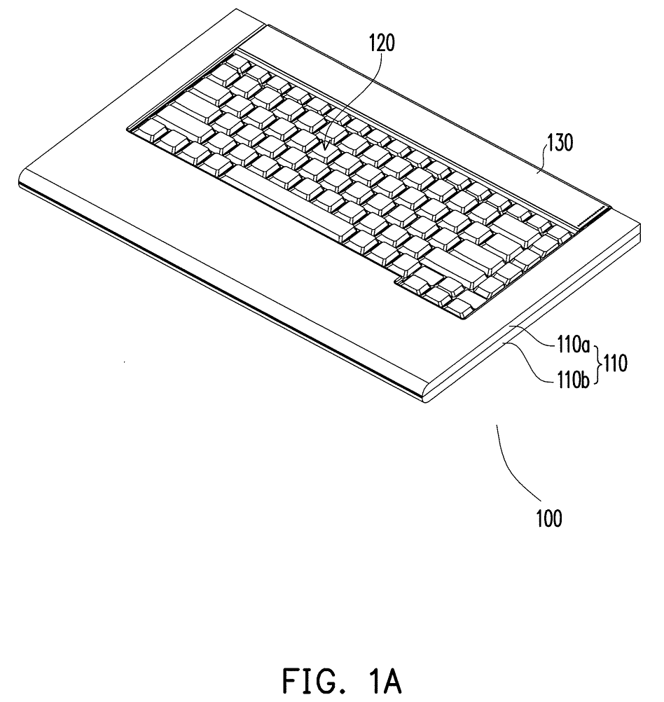

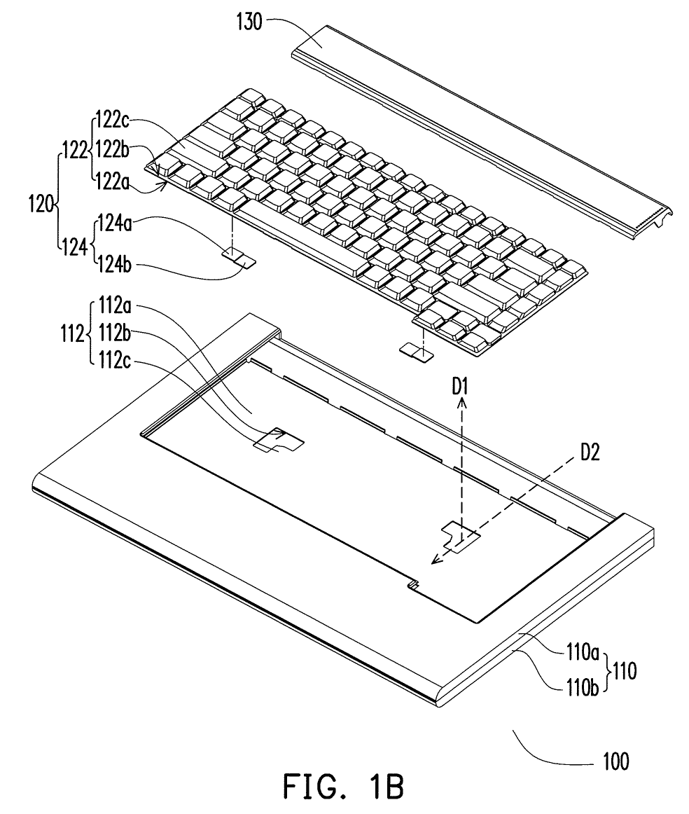

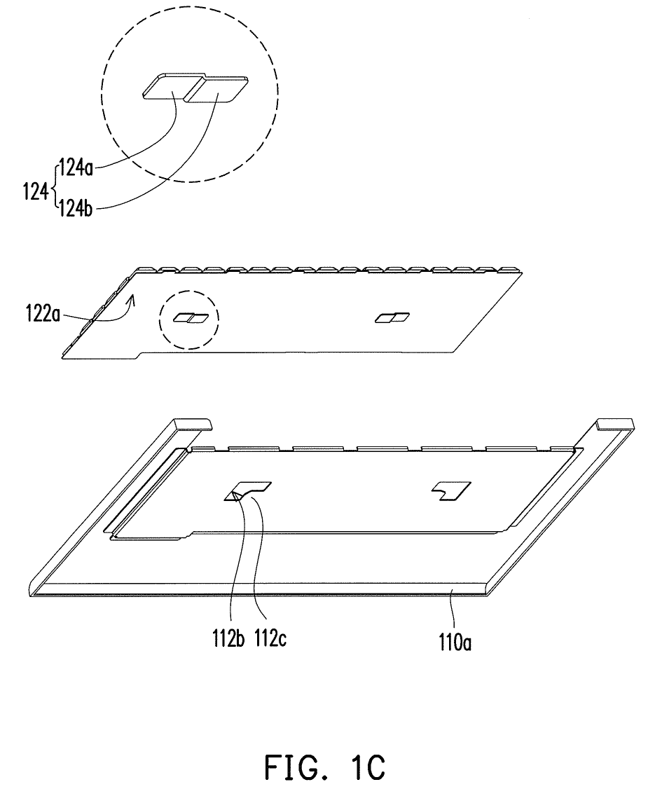

FIG. 1A is a schematic view of an electronic device having a keyboard module according to an embodiment of the present invention. FIG. 1B is a partial exploded view of the electronic device of FIG. 1A. FIG. 1C is a schematic view of a keyboard module and an upper case of FIG. 1B taken from another angle. Referring to FIGS. 1A, 1B, and 1C together, the electronic device 100 of this embodiment is, for example, a host body of a notebook computer. Definitely, the electronic device 100 may also be a cell phone, a personal digital assistant (PDA), or other electronic devices having the keyboard, and this embodiment is not limited thereto.

In this embodiment, the electronic device 100 mainly includes a housing 110, a keyboard module 120, and a limiting plate 130. The housing 110 has an accommodation slot 112 for the keyboard module 120 to be disposed therein. In this embodiment, the simple structural engaging relation between the housing 110 and the keyboard module 120 and the assist of the limiting plate 130 may help to limit the keyboard module 120 in the accommodation slot 112. In detail, the housing 110 consists of an upper case 110a and a lower case 110b. The accommodation slot 112 is disposed on the upper case 110a, for the keyboard module 120 to be disposed therein. Hereinafter, the constitution of the keyboard module 120, the structure of the accommodation slot 112, and the engaging relation between the keyboard module 120 and the housing 110 of this embodiment will be illustrated in detail.

Referring to FIGS. 1A, 1B, and 1C continuously, the accommodation slot 112 of this embodiment has a carrying portion 112a, at least one opening 112b (two openings 112b as shown in FIG. 1B) penetrating the carrying portion 112a, and a first wedging portion 112c located on the edge of the opening 112a. The keyboard module 120 includes a keyboard 122 adapted to be disposed in the accommodation slot 112 and at least one wedging element 124 (two wedging elements 124 as shown in FIG. 1B) corresponding to the first wedging portion 112c. The keyboard 122 has a first surface 122a facing the carrying portion 112a and a second surface 122b opposite to the first surface 122a, and the second surface 122b has multiple keys 122c.

Accordingly, the wedging element 124 of the keyboard module 120 is disposed on the first surface 122a of the keyboard 122. The first wedging portion 112c is adapted to be limited between the wedging element 124 and the first surface 122a in a first direction D1 perpendicular to the first surface 122a. In detail, the wedging element 124 of this embodiment may include a connection portion 124a and a second wedging portion 124b. The connection portion 124a is connected to the first surface 122a of the keyboard 122, and the second wedging portion 124b is bent from the connection portion 124a and is adapted to be engaged with the first wedging portion 112c. In this embodiment, the engaging relation between the first wedging portion 112c and the second wedging portion 124b is used to limit a displacement of the keyboard module 120 in the first direction D1.

After the first wedging portion 112c and the second wedging portion 124b are engaged to limit a displacement of the keyboard module 120 in the first direction D1, in this embodiment, the limiting plate 130 is further disposed in the housing 110 to limit a displacement of the keyboard module 120 in a second direction D2 (the second direction D2 is, for example, perpendicular to the first direction D1). Hereinafter, the manner of the keyboard module 120 assembled onto the housing 110 and fixed in the accommodation slot 112 of this embodiment will be illustrated in detail in accompanying with the drawings.

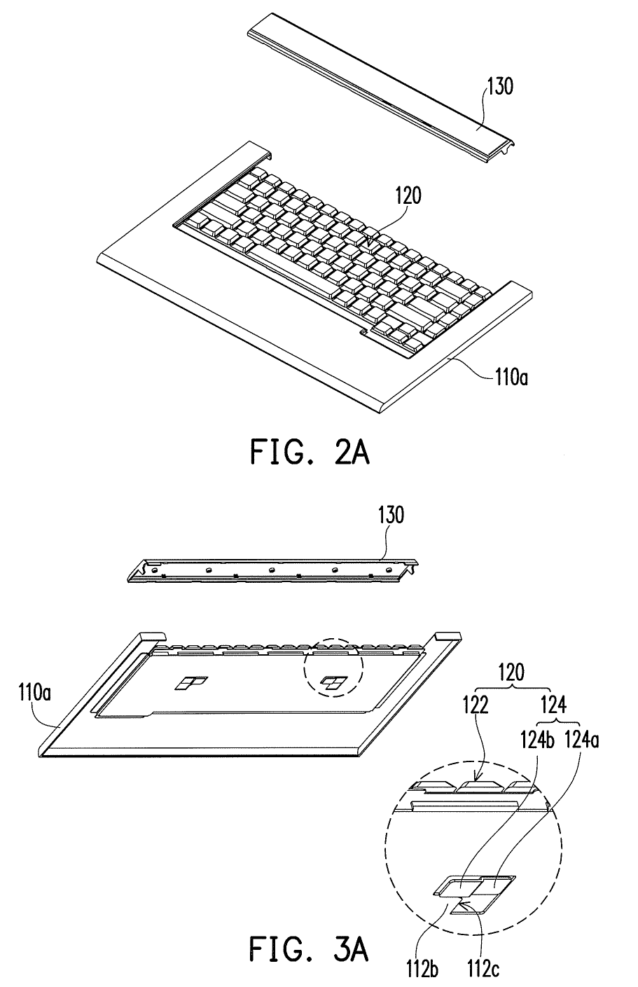

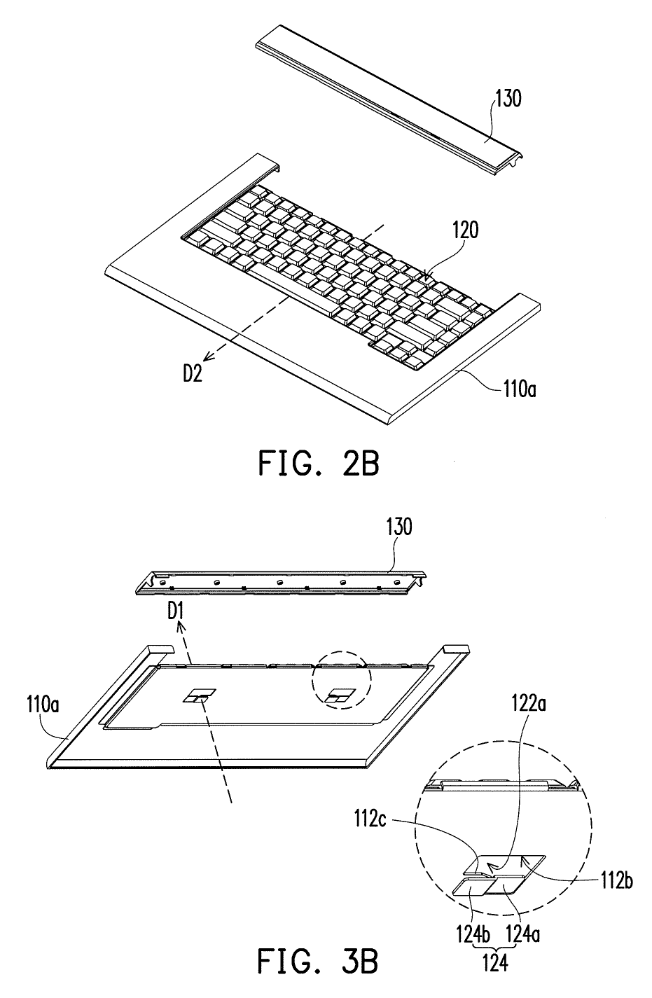

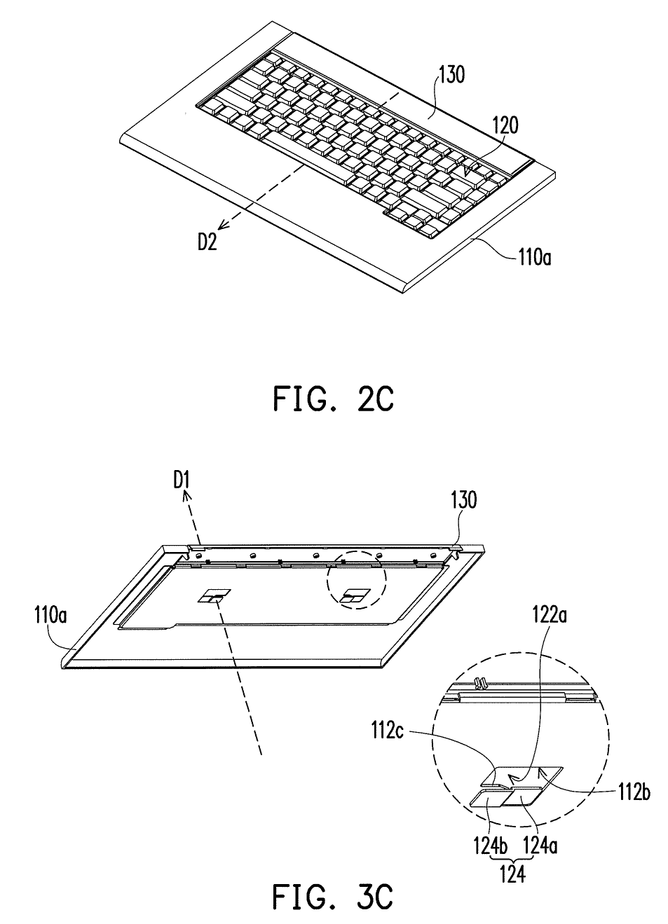

FIGS. 2A to 2C are schematic views illustrating processes of fixing the keyboard module of FIG. 1B in the accommodation slot. FIGS. 3A to 3C are schematic views of FIGS. 2A to 2C taken from another angle respectively. For clearly demonstrating the assembly processes of the keyboard module, only the keyboard module 120, the upper case 110a, and the limiting plate 130 are illustrated in FIGS. 2A to 2C and FIGS. 3A to 3C. Referring to FIGS. 2A and 3A together, the keyboard module 120 may be directly disposed in the accommodation slot 112 (for example, as shown in FIG. 1B). The keyboard 122 of the keyboard module 120 is carried on the carrying portion, and the wedging element 124 of the keyboard module 120 is disposed at the corresponding opening 112b. In more detail, when the keyboard module 120 is disposed in the accommodation slot 112, the connection portion 124a of the wedging element 124 is disposed in the opening 112b, and the second wedging portion 124b bent from the connection portion 124a is bent into a position below the opening 112b.

Then, referring to FIGS. 2B and 3B together, the keyboard module 120 is pushed along the second direction D2 to move the second wedging portion 124b of the wedging element 124 to a position below the first wedging portion 112c. The first wedging portion 112c is limited between the second wedging portion 124b and the first surface 122a in the first direction D1. In other words, the displacement of the keyboard module 120 is limited by the first wedging portion 112c in the first direction D1. Afterwards, as shown in FIGS. 2C and 3C, the limiting plate 130 is disposed in the upper case 110a to effectively limit the displacement of the keyboard module 120 in the second direction D2. In this manner, the displacements of the keyboard module 120 are limited in the first direction D1 and the second direction D2. Thereby, the keyboard module 120 can be effectively fixed on the upper case 110a of the housing.

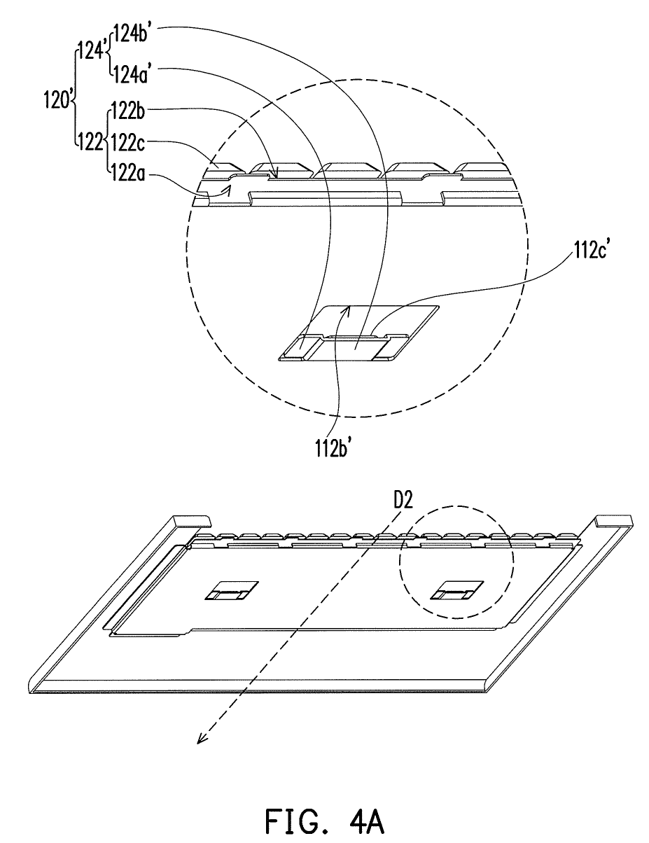

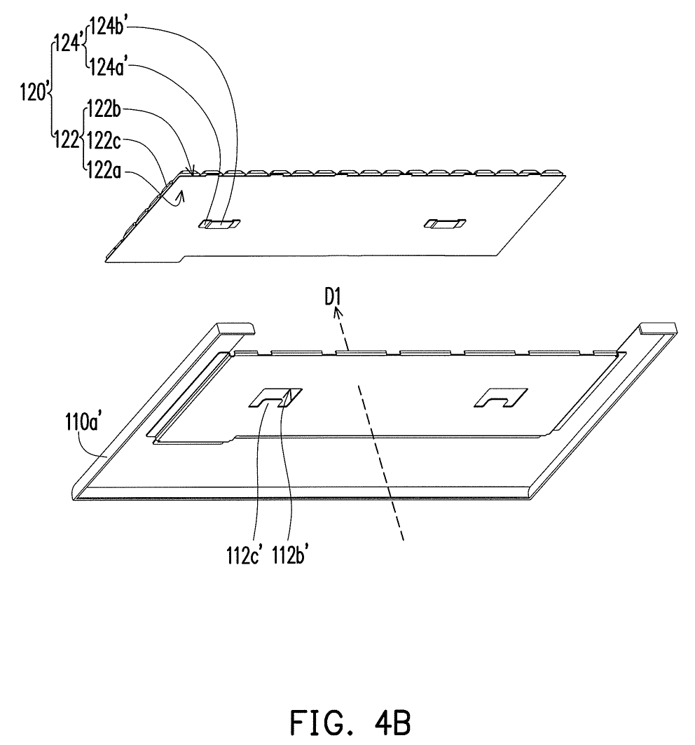

Definitely, in other embodiments, the wedging element may have other structural designs, and the design of the first wedging portion and the opening of the housing may also be appropriately altered corresponding to the wedging element. For example, the wedging element 124′ of another embodiment includes two connection portions 124a′ and a second wedging portion 124b′. Referring to FIGS. 4A and 4B, FIG. 4A is a schematic view of a keyboard module fixed on an upper case according to another embodiment, and FIG. 4B is an exploded view of the keyboard module and the upper case of FIG. 4A. In this embodiment, the connection portions 124a′ are bent from two sides of the second wedging portion 124b′, and are connected to the first surface 122a of the keyboard 122. Furthermore, the design of the first wedging portion 112c′ and the opening 112b′ is appropriately altered corresponding to the wedging element 124′. When the keyboard module 120′ is fixed on the upper case 110a′, the first wedging portion 112c′ is also limited between the second wedging portion 124b′ and the first surface 122a of the keyboard 122. That is, the displacement of the keyboard module 120′ is also limited by the first wedging portion 112c′ in the first direction D1. Definitely, the limiting plate may also be used to facilitate limiting the displacement of the keyboard module 120′ in the second direction D2 in this embodiment, so as to stably fix the keyboard module 120′ on the upper case 110a′.

Further, the assembly processes of the keyboard module 120′ fixed on the housing 110′ are similar to those of the above embodiment, and the details will not be described herein again.

In view of the above, in the present invention, at least one wedging element is disposed on a surface of the keyboard facing the accommodation slot, and the engaging relation between the wedging element and the wedging portion of the housing enables the keyboard module to be evenly and conveniently fixed on the housing. Since the present invention uses a simple structural engaging relation to fix the keyboard module on the housing without requiring the conventional screw-locking process, the number of the screws is reduced and the time cost for tightening the screws is also lowered. Therefore, the electronic device of the present invention achieves a better manufacturing performance with a lower production cost.

Moreover, since the wedging element is disposed on the bottom surface of the keyboard for engaging the housing in the present invention, when the keyboard module is fixed on the housing, the keyboard of the present invention may be evenly disposed in the accommodation slot of the housing, such that the user when pressing the keys will not perceive the conventional feeling of key floating.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A keyboard module, adapted to be fixed on a housing of an electronic device, wherein the housing is provided with an accommodation slot comprising a carrying portion, at least one opening penetrating the carrying portion, and a first wedging portion located on the edge of the opening, the keyboard module comprising:
a keyboard, comprising a first surface facing the carrying portion and a second surface with multiple keys; and
at least one wedging element, disposed on the first surface of the keyboard, and corresponding to the first wedging portion,
when the keyboard is disposed in the accommodation slot, the first wedging portion is limited between a part of the wedging element and the first surface in a first direction, and the first direction is perpendicular to the first surface.

2. The keyboard module according to claim 1, wherein the wedging element comprises a connection portion and a second wedging portion, the connection portion is connected to the first surface, the second wedging portion is bent from the connection portion, and the first wedging portion is limited between the second wedging portion and the first surface.

3. The keyboard module according to claim 1, wherein the wedging element comprises two connection portions and a second wedging portion, the connection portions are bent from two sides of the second wedging portion and are connected to the first surface, and the first wedging portion is limited between the second wedging portion and the first surface.

4. An electronic device employing a keyboard module, comprising:
a housing, provided with an accommodation slot comprising a carrying portion, at least one opening penetrating the carrying portion, and a first wedging portion located on the edge of the opening;
a keyboard module, comprising:
a keyboard, comprising a first surface facing the carrying portion and a second surface with multiple keys;
at least one wedging element, disposed on the first surface of the keyboard, and corresponding to the first wedging portion,
when the keyboard is disposed in the accommodation slot, the first wedging portion is limited between a part of the wedging element and the first surface in a first direction, and the first direction is perpendicular to the first surface; and
a limiting plate, disposed in the accommodation slot to limit a displacement of the keyboard module in a second direction.

5. The electronic device according to claim 4, wherein the wedging element comprises a connection portion and a second wedging portion, the connection portion is connected to the first surface, the second wedging portion is bent from the connection portion, and the first wedging portion is limited between the second wedging portion and the first surface.

6. The electronic device according to claim 4, wherein the wedging element comprises two connection portions and a second wedging portion, the connection portions are bent from two sides of the second wedging portion and are connected to the first surface, and the first wedging portion is limited between the second wedging portion and the first surface.

7. The electronic device according to claim 4, wherein the second direction is perpendicular to the first direction.

8. The electronic device according to claim 4, wherein the housing comprises an upper case and a lower case, and the accommodation slot is disposed on the upper case, for the keyboard module to be disposed therein.
